(19) United States
(12) Patent Application Publication
(10) Pub. No.: US 2004/0143513 A1
(43) Pub. Date: Jul. 22, 2004

(54) Method for providing personalized programs to retail customers

(76) Inventors: Margaret Aleles, Gladstone, NJ (US); Steven A. Shaya, Highlands, NJ (US); Kathryn Dean Luedtke, Doylestown, PA (US); Mario A. Orlandi, Stanton, NJ (US); Jurgen Fey, Skillman, NJ (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/695,931

(22) Filed: Oct. 29, 2003

Related U.S. Application Data
(60) Provisional application No. 60/422,724, filed on Oct. 31, 2002.

(51) Int. Cl. G06F 17/60

(52) U.S. Cl. 705/26

(57) ABSTRACT

This invention relates to a method of providing an individualized personal care program to a customer in a retail shopping environment. More specifically, the present invention is directed to a method of providing an individualized personal care program to a customer in a retail shopping environment, which entails obtaining personal information from the customer in the retail shopping environment, using the information to create an individualized personal care program for the customer, and providing the individualized personal care program to the customer in the retail shopping environment.

### FIELD OF THE INVENTION

This invention relates generally to a method of providing an individualized personal care program to a customer in a retail shopping environment. More specifically, the invention relates to providing an individualized personal care program to a customer in a retail shopping environment by obtaining objective personal information from the customer in the retail shopping environment, using the personal information to create an individualized personal care program to the customer, and providing the individualized personal care program to the customer in the retail shopping environment.

### BACKGROUND OF THE INVENTION

Retail shopping environments are common outlets in which customers generally shop for and/or purchase consumer products, services, and other necessary items for their own use and the use of their families. Salespeople may be available in such outlets to provide assistance to the customer.

The personal care products, such as skin care and hair care products, that are provided in such outlets are generally available in a multiplicity of sizes, types, brands, colors, styles, and concentrations, with a variety of performance characteristics and other properties. The customer looks at and evaluates the products with respect to his or her own needs and requirements, and attempts to select the products accordingly. In some cases, a salesperson may provide assistance or recommendations to the customer in the selection. However, the salesperson's assistance is based on limited knowledge of the customer's personal information and needs, and of the products that are available. Thus, the customer is ultimately responsible for making the selection. In many cases, the customer may find it difficult to determine the most appropriate personal care product for his or her requirements and may resort to the use of a trial and error approach to selection by buying a first product based on a best guess of its suitability to the customer's needs.

After the first product is used for a period of time, the customer may evaluate the product's efficacy or otherwise determine whether or not the product was indeed appropriate. If, after use, the first product is found not to be suitable, the customer may then return to the same or another retail shopping outlet and select a second product for trial. If, after use of this second product, the customer determines that the second product is not suitable either, a third product may be purchased. This trial and error process may continue until the customer either finds a product that is suitable, or, out of frustration, compromises on the use of a product that is not entirely suitable. The whole process of trial and error is time-consuming, costly, and frustrating to the customer.

Likewise, some retail shopping outlets may also offer a variety of services to customers for the use of the customers and their families. In such cases, also, although salespeople may be available to advise the customer about the services, the customer must evaluate and attempt to select the most appropriate service for his or her own needs. Again, the customer must often use a trial and error approach to finding the right service to meet his or her needs.

In general, the retail shopping environment tends to be impersonal. The customer is left substantially alone to pick and choose the personal care products and services that are most suited to his or her own needs and preferences. This can be a daunting task to most customers because of the vast range of products and services available in different outlets from which to select, even within a single category, such as hair care or skin care.

Often, too, the customer's personal care needs may include a need for education, such as, for example, skin care, hair care, or wellness education. The customer may also have a particular skin or hair condition that should be evaluated by a dermatologist, although the customer is unaware of this fact. Alternatively, the customer may be unsure whether a particular skin or hair condition is normal or should be evaluated by a doctor.

A customer's personal care needs may also include needs for products, services, or activities for enhancing or promoting the customer's wellness. For example, the customer may been experiencing high levels of stress in general in his or her daily life, which then causes elevated levels of stress hormones, which are known to have adverse health effects. The customer may need products or services that can help him or her to relax, thereby reducing the levels of stress hormones and the consequent adverse health effects. Currently, there are no services available to assist the customer to obtain access to individually appropriate products and services.

A need exists for a method of providing customers in a retail shopping environment with an individualized personal care program based on the customer's own personal information.

### SUMMARY OF THE INVENTION

The present invention relates to a method of providing an individualized personal care program to a customer in a retail shopping environment. More specifically, the present invention is directed to a method of providing an individualized personal care program to a customer in a retail shopping environment, which entails obtaining personal information from the customer in the retail shopping environment, using the information to create an individualized personal care program for the customer, and providing the individualized personal care program to the customer in the retail shopping environment. The personal information obtained from the customer includes objective information. The individualized personal care program has at least two of the following elements: a recommendation for at least one personal care product, a recommendation for at least one personal care activity, and a recommendation for at least one personal care service.

In another embodiment, the present invention relates to a method of providing an individualized personal care program to a customer in a retail shopping environment, which entails obtaining personal information, including objective information, from the customer in the retail shopping environment, and using the personal information to generate individualized personal care needs for the customer. An individualized personal care needs assessment is created by evaluating the individualized personal care needs against standards that reflect needs for at least two of the following: needs for personal care services, needs for personal care activities, and needs for personal care products. The individualized personal care needs assessment is used to create an individualized personal care program, which has at least one of the following: a personal care product, a personal care service, or a personal care activity. The individualized personal care program is then provided to the customer.

In another embodiment, the present invention relates to a method of providing a personalized skin care program to a customer, which involves obtaining personal information from the customer in a first retail location, using the information to create a personalized skin care program for the customer, and providing the personalized skin care program to the customer. The personalized skin care program has at least two of the following elements: a recommendation for at least one skin care product, a recommendation for at least one skin care activity, and a recommendation for at least one skin care service.

The first retail location is one of a plurality of retail locations that are in data communication with one another. Preferably, all the retail locations are in data communication with one another. Thus, the data relating to the personal information and the personalized skin care program may be communicated from the first retail location to any one of the plurality of retail locations that are in data communication with one another. Likewise, the data relating to the personal information and the personalized skin care program may be retrieved from any one of the plurality of retail locations that are in data communication with one another. The data may be updated or changed at a second retail location and may be retrieved from any one of the plurality of retail locations that are in data communication with one another.

### BRIEF DESCRIPTION OF THE DRAWINGS

FIG. 1 is a flow diagram of the process of an embodiment of the present invention.

FIG. 2 shows a logical flow diagram of the process for obtaining personal information of an embodiment of the present invention.

FIG. 3 shows a logical flow diagram of the process for a skin image acquisition of an embodiment of the present invention.

FIG. 4 shows a flow diagram of the process for creating a personalized skin care program of the present invention.

FIG. 5 shows an example of a personalized skin care program according to one embodiment of the present invention.

FIG. 6 shows an example of a personalized wellness program according to one embodiment of the present invention.

### DETAILED DESCRIPTION OF THE INVENTION

According to the present invention, methods are described for providing customers with individualized personal care programs in retail shopping environments. Specifically, in one embodiment, the method of this invention relates to a method of providing a customer with a personalized skin care program in a retail shopping environment, including, in a retail shopping environment,

a) obtaining personal information from a customer, the personal information comprising objective information;

b) using the personal information to create a personalized skin care program for the customer; and

c) providing the personalized skin care program to the customer, wherein the personalized skin care program has at least two elements selected from the following: a recommendation for at least one skin care product, a recommendation for at least one skin care service, and a recommendation for at least one skin care activity.

As used herein, “retail shopping environment” includes business establishments stocked with items for sale where consumers go to examine goods and services with the possible intent to buy for their personal or household use. Examples of such retail shopping environments include, without limitation, department stores, shopping malls, shopping centers, kiosks, drug stores, mass merchandisers, specialty shops, grocery stores, and convenience stores. Typically, consumers may come and go freely during the normal operating business hours of these retail shopping environments. In other words, customers do not need to make appointments to visit such retail shopping environments.

As used herein, “wellness” means the quality or state of being in good general health, including physical health, emotional health, spiritual health, and mental health, and a “wellness program” means a program or regimen or plan for actively seeking a state of good or improved general health or of improving one's health in one or more specific areas with a goal of attaining a state of good or improved general health. Specific areas which are elements of and may affect one's general health and for which improvement may be sought include, without limitation, weight management, sleep, skin health, memory, learning, concentration, energy level, mood, emotional health, cardiovascular health, fertility and reproductive health, nutrition, exercise/activity, and immune system health.

The personal information that is obtained from the customer may be subjective information or objective information. Subjective information may be obtained from the customer by questioning means, that is, by the customer's answering questions, which are asked of him or her, either orally or in written form, or electronically, such as via a computer terminal or other electronic device. The questioning means may be an interviewer asking oral questions of the customer, a written questionnaire on which the customer writes answers to the written questions, or an electronic questionnaire viewed by the customer on a computer screen or other electronic video device and for which the customer submits answers to the questions by typing on a keyboard, touching a responsive screen, speaking an answer, or the like.

Subjective information may include, without limitation, age, hair color, eye color, height, weight, ethnic background, self-described lifestyle information, skin care habits, skin care product use preferences, skin color, personal skin history, exercise habits, cosmetic and fashion color preferences, skin sensitivity, skin problems and concerns, skin care questions, dietary habits, allergies, stress levels, sleep habits, allergies, skin oiliness, and skin sensitivity, and menstrual cycle information. Lifestyle information may include such information as occupational environmental conditions (i.e., dusty, warm, cool, dry, humid), average exposure to sun and wind and outdoor environmental conditions, average daily computer usage, use of eyeglasses or contact lenses, use of sunglasses, and the like.

Other personal information may be objective information, that is, it may be obtained by measuring certain properties or qualities, such as, for example, by taking physical or biological or other objective measurements. For example, skin imaging may be used to measure skin qualities, such as sagging, firmness, wrinkles, skin pigmentation, photodamage, skin blotchiness, pore size and condition, presence and concentration of P. acnes bacteria, skin dryness, skin oiliness. Suitable imaging techniques for measuring these characteristics are described in commonly owned, copending U.S. patent applications with Ser. Nos. 10/007,296 and 10/008,753, which are incorporated herein by reference.

Further nonlimiting examples of objective information relating to the skin include skin roughness, photodamage, skin elasticity, measured surface reflectance, redness, skin moisture content (measured by capacitance or conductance), skin barrier function (measured by Transepidermal Water Loss following wetting), coefficient of friction of the skin surface, epidermal hyperplasia, skin flake image analysis, skin lesion size and color and location, basal skin color, pigmented spot color, skin color evenness, skin wrinkle length or depth, skin sagging, skin rigidity, skin hydration, acne lesion counts, acne lesion color, hyperpigmentation count or color or size or area, surface corneocyte size or shape or nucleation, mechanical stiffness in the plane of and perpendicular to the skin surface, microbial population, surface energy, three-dimensional contour of sagging skin, skin disease, visible vasculature, and general health parameters that are known to affect the skin.

Objective information concerning hair may include, without limitation, hair color, thickness, length, morphology, dryness, brittleness, regions of hair loss or thinning.

Objective information may also be provided via an assessment of the customer's skin or hair by a professional skin or hair care consultant. The consultant may examine the customer's skin and assess it for such characteristics as wrinkle frequency or depth or length, pigmentation, firmness, sagging, oiliness, dryness, the presence of lesions or redness, or pore size. Likewise, the consultant may examine the customer's hair and assess it for such characteristics as brittleness, split ends, shape in relation to facial structure, color, hair shaft damage, dryness, oiliness, or frizziness.

After the personal information is collected from the customer, it is used to create an individualized personal care program for the customer. The information may be used to generate scores according to predetermined rules, formulae or algorithms, and these scores used in the selection of the elements of the individualized personal care program.

The personal information may be used to generate individualized personal care needs for the customer. These individualized personal care needs are then evaluated against standards that reflect needs for at least two of the following: needs for personal care products, needs for personal care services, and needs for personal care activities. This evaluation is then used to create an individualized personal care needs assessment. The individualized personal care needs assessment is used to create the individualized personal care program for the customer. The individualized personal care program has at least one of the following: a personal care service, a personal care product, or a personal care activity. The individualized personal care program is then provided to the customer, preferably in the retail environment. Alternatively, the personal care program may be in a written form, which may be provided to the customer through the mail or electronically, such as by electronic mail.

The elements of the individualized personal care program preferably include at least two of the following: a recommendation for at least one personal care product, a recommendation for at least one personal care service, and a recommendation for at least one personal care activity.

Personal care products may be skin care products, hair care products, wellness products, or any combination of these. Exemplary skin care products include, without limitation, cleansers, moisturizers, skin firming treatments, skin lighteners, skin darkeners, sunscreen formulas, skin wrinkle treatments, anti-aging products and treatments, acne products and treatments, oil-controlling products and treatments, toners, sensitive skin products and treatments, unwanted hair diminishing products, skin renewal products, sunless tanning products, astringents, color cosmetics, and the like.

Skin care services may include facials, masks, facial treatments, make-up consultations, fashion color consultations, massages, tanning services, unwanted hair removal procedures, manicures, pedicures, and the like.

Skin care activities may include educational seminars or programs, appointments or consultations with dermatologists or other medical professionals, lifestyle changes, nutritional counseling, exercise programs, and the like. The customer's participation in the recommended skin care activities may take place in the retail location or at an alternate location. For example, an appointment with a dermatologist might take place in the office of the dermatologist or in the retail location, where the dermatologist may visit. Likewise, educational seminars may be offered in the retail location or at an alternate location.

Hair care products may include appropriate shampoos and conditioners for particular characteristics of the hair, as well as individually appropriate hair care implements such as brushes, combs, nets and styling devices. Hair care services may include washing with appropriate shampoos and conditioners, styling with appropriate styling methods and products, permanent waving, hair straightening, hair coloring and cutting (in particular, coordination of optimal hair color and cut with skin and eye color and face morphology) and the like.

Once the elements of an individualized personal care program have been identified, the program is preferably provided to the customer in the retail shopping environment. The program is preferably provided to the customer through one or more personal care counseling sessions. Alternatively, the program may be provided to the customer through a written report. Preferably, the program is provided to the customer through one or more counseling sessions, at which time, the customer also receives a written report of the personal care program.

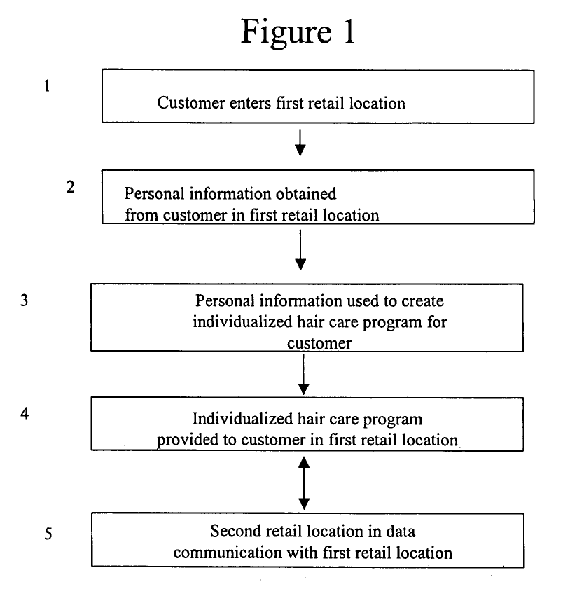

Referring now to FIG. 1, in a first part 1, a customer enters a first retail location. In part 2, the customer provides personal information in the first retail location. As described hereinbefore, the personal information may be subjective personal information or objective personal information, or preferably, a combination of subjective and objective personal information.

The personal information is then used to create an individualized personal care program for the customer in part 3, and the individualized personal care program is provided to the customer in part 4. The personal care program has at least two of the following: a recommendation for at least one personal care product, a recommendation for at least one personal care activity, and a recommendation for at least one personal care service. The personal care program may be provided to the customer by a counseling session with a professional personal care consultant or by a written report, or preferably, by both a counseling session with a professional personal care consultant and a written report. As shown in part 5, the first retail location is in data communication with a second retail location. Thus, the customer may later visit the second retail location and retrieve his or her personal information and individualized personal care program from the first location.

In another embodiment, the invention relates to a method of providing a personalized skin care program to a customer, comprising, in a first retail location:

a) obtaining personal information from a customer;

b) using the personal information to create a personalized skin care program for the customer;

c) providing the personalized skin care program to the customer, wherein the personalized skin care program has at least two elements selected from the following: a recommendation for at least one skin care product, a recommendation for at least one skin care activity, and a recommendation for at least one skin care service;

d) wherein the first retail location is one of a plurality of retail locations in data communication with one another.

As used herein, “retail location” refers to a particular business establishment in one place stocked with items for sale where consumers go to examine goods and services with the possible intent to buy for their personal or household use. Examples of such retail locations include, without limitation, department stores, shopping malls, shopping centers, kiosks, drug stores, mass merchandisers, specialty shops, grocery stores, and convenience stores. Typically, consumers may come and go freely during the normal business operating hours of a retail location. In other words, customers do not need to make appointments to visit such retail locations.

The first retail location is one of a plurality of retail locations that are in data communication with one another. As used herein, “data communication” means that data such as personal customer information and personalized skin care program information may be transmitted or exchanged from a first retail location to a second retail location, or retrieved from the first retail location by a second retail location. The data communication preferably occurs by way of a network environment. Network environments may be arranged in a variety of configurations, and the invention is in no way intended to be limited to the examples and embodiments described herein. An example of a network environment is a client-server system, which includes client computers, which may be personal computers, hand-held computing devices, and the like. The client-server system also includes at least one server computer, which is coupled to and controls a storage element.

The client and server computers communicate with one another by way of a communications network, which may comprise any number of networking technologies such as a LAN, a WAN, an intranet, the Internet, and the like. In such a client-server system, the data comprising the personal customer information and the personalized skin care programs is stored electronically in a database residing on the storage element. Each of the plurality of retail locations has a client computer which may access the data via the network linking the client-server system. Additionally, the client computers may communicate with one another via the network.

In an alternative embodiment, a client computer may transmit data to another client computer other than a client computer in one of the plurality of retail locations. For example, the data may optionally be transmitted to a client computer in a dermatologist's or other professional's office, such as might be helpful if the customer were visiting a dermatologist as a result of receiving a recommendation to see a dermatologist as part of her personalized skin care program. In such a case, the dermatologist might find it useful to see the images of the customer's skin that were obtained in the first retail location.

A customer may visit a first retail location and obtain a personalized skin care program at that location. The personal information and the personalized skin care program are retained by the first retail location with a personal identifier unique to the customer. Later, the customer may visit a second such retail location in data communication with the first. The second retail location may access her personal information and her personalized skin care program via the personal identifier, and allow the customer to access and view the information and the program. A professional skin care consultant at the second retail location also may access and view the customer's personalized skin care program with the customer's permission, so that the consultant can provide advice to the customer with regard to the personalized skin care program.

In another embodiment of the invention, primary personal information is obtained from a customer, and the customer is provided with an initial personalized skin care program in a first retail location in the same manner as in preceding embodiments. The primary personal information and the initial personalized skin care program are retained by the first retail location with a personal identifier unique to the customer. After a time, the customer returns to the first or to a second retail location in data communication with the first, and secondary personal information is obtained from the customer. The primary personal information and the initial personalized skin care program are retrieved according to the customer's unique personal identifier. The secondary personal information may then be compared to the primary personal information and is used to create a secondary personal skin care program, which is then provided to the customer. The secondary personal skin care program has at least two elements selected from the following: a recommendation for at least one skin care product, a recommendation for at least one skin care activity, and a recommendation for at least one skin care service. The secondary personal skin care program may be similar to the initial skin care program if the customer's secondary personal information is similar to the customer's primary personal information. Alternatively, the secondary personal skin care program may have one or more elements that differ from the elements of the primary personal skin care program.

However, if the customer's secondary personal information is different from the customer's primary personal information, the secondary skin care program may be different from the initial skin care program. Thus, if the customer follows the recommendations of the initial skin care program, her skin condition may change, and she may need a different type of skin care product or service or activity. Thus, the secondary personal information would reflect this skin condition change, and the secondary skin care program would also reflect the different needs related thereto.

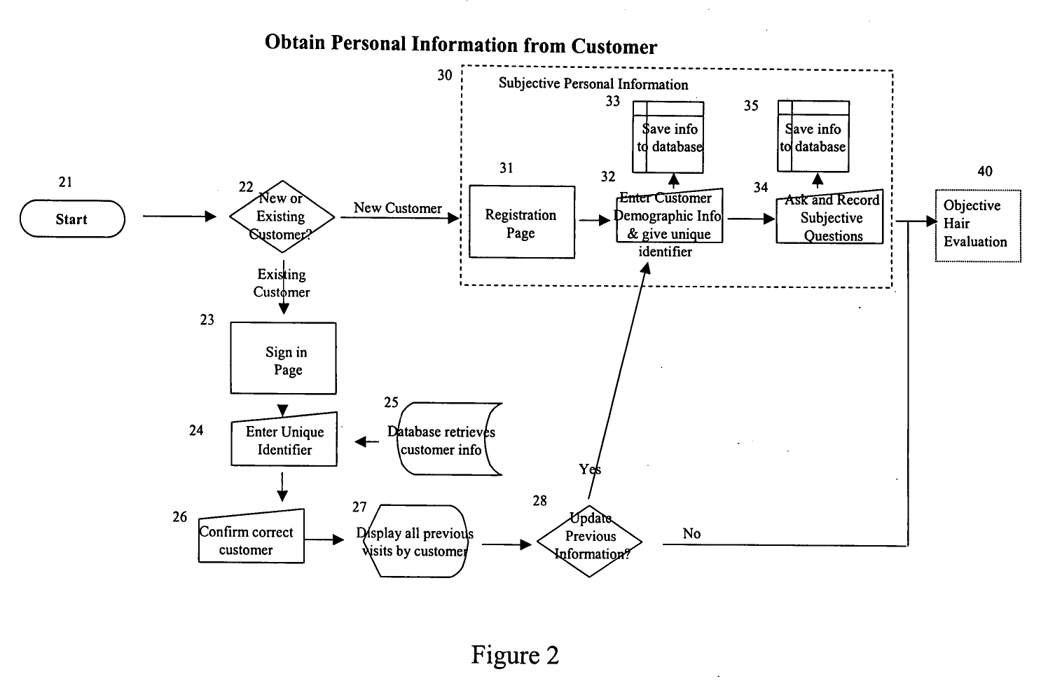

Over time, as the customer continues to visit the retail locations and receive updated personalized skin care programs, a history of her skin condition and its response to the product, services, and activities of her personalized skin care programs is established. This historical information may then be used to develop, refine, or support standards used in creating the recommendations of future products, services, and activities for this and other customers. In a further embodiment of the invention, the personal information includes images of the customer and objective scores based on the images. As illustrated in FIG. 2, a customer enters a retail outlet 21 and a determination is made as to whether the customer is a new or an existing customer 22.

If the customer is returning as an existing customer, she signs in at a sign-in page 23 using her unique identifier 24, or user name and ID. A database then retrieves the customer information 25 associated with her unique identifier. A confirmation step 26 ascertains that the unique identifier is the correct one for the customer, and records of her previous visits are displayed 27. The records of her previous visits may include her personal customer information, her previously acquired digital images, her previous answers to self-perception questions, and any other information about the customer that may have been stored in the database, including her personalized skin care program. If the customer wishes to add or change information that is different from her information from previous visits 28, she may then proceed to update her information with new images, new personal information, or new answers to the same or different self-perception questions, as in the Subjective Personal Information step 30.

If the customer is new, she is asked to complete a registration page 31, on which she enters her customer demographic information. She is given a unique identifier 32. This customer demographic information is saved in a secure database 33 with the unique identifier. Subjective questions are then asked of the customer 34 and her answers to these questions are also saved in a secure database 35 along with the unique identifier.

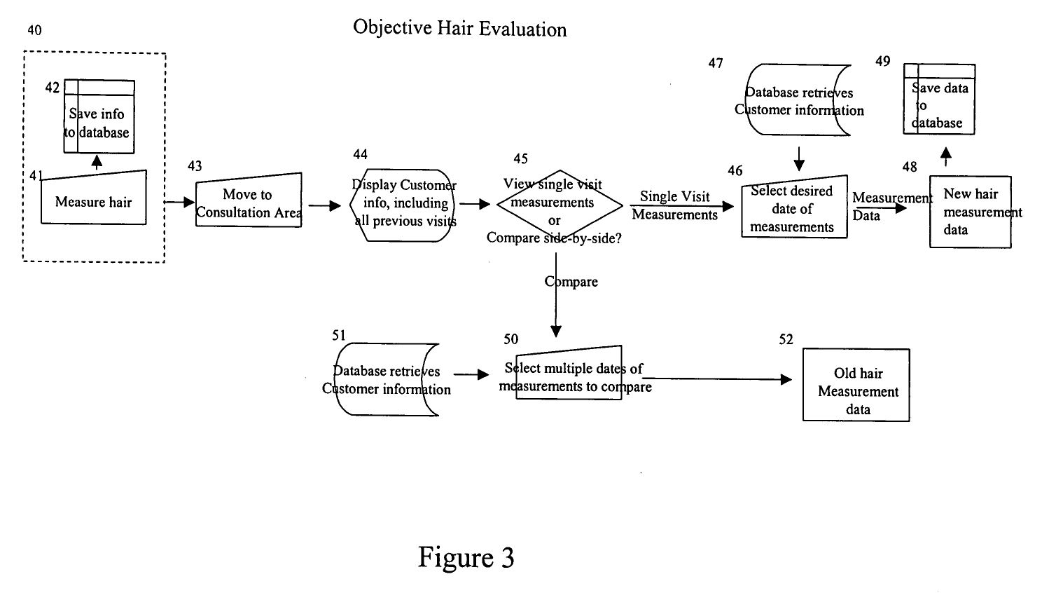

As shown in FIG. 3, digital images of the customer are then acquired 41 and stored in the same or a different database 42 with the unique identifier. The customer is then asked to meet with a consultant and view the images in an image viewing room 43, at which time the customer's personal information is displayed, including any personal information from previous visits 44. The customer selects whether to view only a single image or a side-by-side comparison of two images 45. If this is the customer's first visit, there is only one image to view; however, if the customer had previous visits, she may choose whether or not to view a comparison of two images 50, in which case, customer information including earlier images is retrieved from a database 51. If earlier images are selected, the customer personal information will also include old image scores 52, or image scores from images taken on previous visits.

If this is the customer's first visit, or if the customer chooses to view only one image, the customer selects the date of the image 46 that she wishes to view. The image and related customer information is retrieved from a database 47 where it is stored. The customer information also includes new skin image scores.

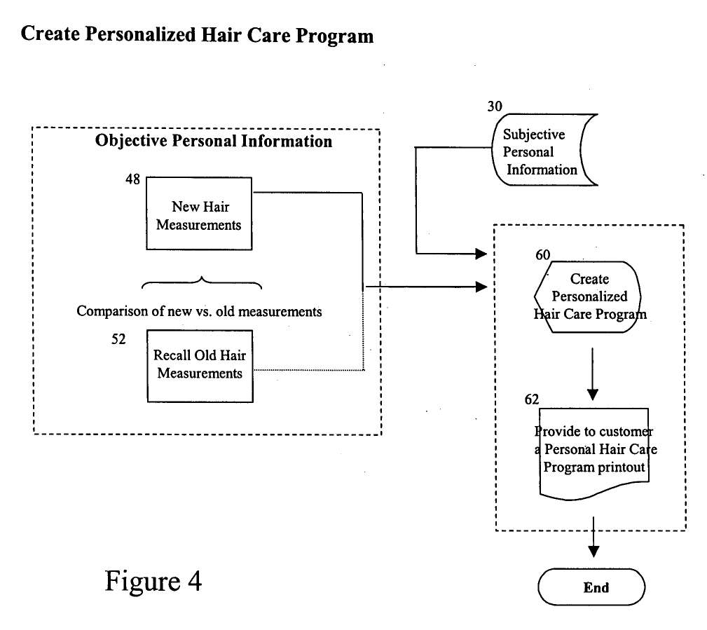

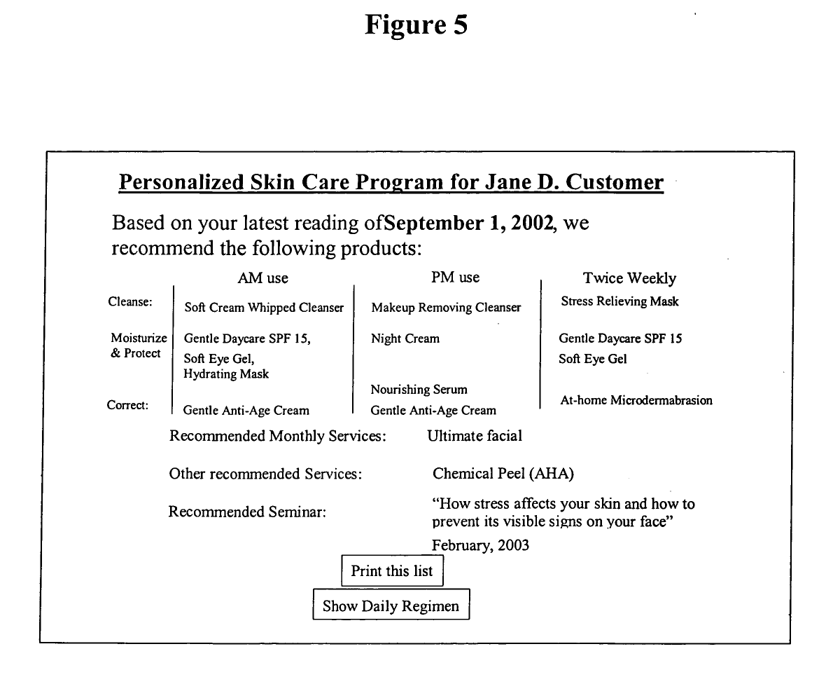

As shown in FIG. 4, the objective personal information comprising the new skin image scores 48 and, optionally, old skin image scores 52, are combined with subjective personal information 30 to create a personalized skin care program 60. This personalized skin care program is then provided to the customer 62 in the form of a personalized skin care program print-out, or written report. An example of a personalized skin care program is illustrated in FIG. 5. Preferably, the personalized skin care program is also provided to the customer through a counseling session with a professional skin care consultant.

An example of a method of using the customer's personal information to create a personalized skin care report involves first assigning scores to a customer's skin care needs. These scores are based upon objective information, such as her skin image scores. Other scores may also be assigned to the customer's subjective information, such as, for example, customer age scores, skin sensitivity scores, customer product preference scores, and the like. These scores that are assigned to the customer's subjective information are based upon a standardized scale that assigns a score to each potential answer a customer may provide to each subjective question. The scores may be based on a range, such as from 1-5, or on a binary system, such as “yes” or “no”. The skin care consultants are preferably trained in the use of the scale so that it is applied consistently by all consultants to all customers in all retail locations. These personal information scores serve to quantify the customer's skin care needs.

Likewise, each of the possible products, activities, and services that may be offered to a customer are matched with the appropriate scores or ranges of scores for the appropriate skin care needs. These matches represent standards that reflect the skin care needs associated with the personal information scores. For example, a moisturizer is matched to a range of skin dryness scores that indicate the customer has dry skin. This same moisturizer is not matched to the range of skin dryness scores that indicate the customer has very oily skin. In this case, an oil-control product is matched to skin dryness scores that indicate very oily skin.

In some cases, the customer's skin care needs will include scores that indicate she should use a certain product for one condition, although that product may not be appropriate for another condition. In such cases, the scores associated with certain conditions will be given greater weight than others. Generally, the scores associated with conditions about which the customer has greater concerns will be given the most weight in evaluating for the appropriate products, services, and activities. However, in some situations, a certain product activity, or service is indicated for one skin condition, but would be harmful to another skin condition. In such cases that product, activity, or service is not recommended.

This evaluation of the customer's personal skin care needs against the standards that reflect needs for certain products, activities, and services, results in the customer's individualized skin care needs assessment. This needs assessment is used to create the customer's personalized skin care program.

### EXAMPLE 1

### Method of Providing a Personalized Skin Care Program

In one embodiment of the present invention, a customer enters the retail location and identifies herself as a new customer. She is greeted by a professional skin care consultant, who asks her to provide some personal information by completing a registration page and further questionnaire. The customer is invited to sit at a computer terminal where she views and completes the registration page and answers the questions of the questionnaire. Completion of the registration page involves providing first and last names, address, mother's maiden name (for security purposes and identification confirmation), phone number, email address, gender, age bracket. The questionnaire involves further questions about how the customer found out about the retail location, where she/he usually shops for skin care products, brands of skin care products most frequently used, existing or planned pregnancy, dermatologist visits within the past year, sunburn history, prescription skin care product usage, history of laser hair or wrinkle treatments, history of collagen or botox injection, and history of spa visits or spa treatments. She then receives a unique personal identifier, which is her membership number. The personal information is saved to a database with the unique personal identifier. She then answers self-perception questions, which she may answer by selecting one of multiple possible answers. Nonlimiting examples of self-perception questions include questions about lifestyle information, skin care product use preferences, personal skin history, exercise schedule, cosmetic and fashion color preferences, skin sensitivity, skin problems and concerns, skin care questions, dietary habits, allergies, stress levels, sleep habits, how sensitive her skin is, how prone to acne or break-outs her skin is, how concerned she is about facial hair, how concerned she is about lines/wrinkles in the throat area, how her skin changes over the course of her menstrual cycle, and how concerned she is about pigmentation or spots in the decolletage area. The personal information comprising her answers to these self-perception questions is also saved to a database in conjunction with her unique personal identifier.

Next the customer is asked to push her hair back from her face and secure it with a black headband. A black or dark gray drape is placed over her shoulders so that it covers her clothing that is closest to her face and neck. The customer is then asked to place her chin on a chin-rest which has been placed and secured in position in front of a camera lens. She is asked to close her eyes and, without smiling, to hold her lips slightly touching each other, and the camera is activated to take her picture and produce a digital image.

Ultraviolet Photography

In one embodiment, the camera takes an ultraviolet photograph of the customer. What is meant by “ultraviolet photograph” is a photograph of the customer taken (i) with a light source that either emits substantially only ultraviolet light (radiation) or emits light through an ultraviolet filter and/or (ii) through an ultraviolet filter that filters the light prior to or after entering the camera's lens. What is meant by an ultraviolet filter is a filter that filters incoming light to emit substantially only ultraviolet light (e.g., light having a wavelength from about 200 to about 400 nm). Examples of light sources that can emit substantially only ultraviolet light are light emitting diodes. Examples of ultraviolet photography include, but are not limited to, ultraviolet A photography or ultraviolet B photography, which are further described hereinbelow. This camera produces an image in which the appearance of pigmentation, and photodamage of the skin are enhanced. This enhanced pigmentation and photodamage may be assessed for intensity by image analysis using a standard image analysis software program and given a severity score, based on a 5-point range, from 1-5.

Ultraviolet A Photography.

In one embodiment, the method includes the step of taking an ultraviolet A photograph of the customer. What is meant by “ultraviolet A photograph” is a photograph of the customer taken (i) with a light source that emits substantially only ultraviolet A light or emits light through an ultraviolet A filter and/or (ii) through an ultraviolet A filter that filters the light prior to or after entering the camera's lens.

In one embodiment, one or more, preferably two, flash units are filtered with an ultraviolet A filter (“UVA filter”). What is meant by a UVA filter is a filter that filters incoming light to emit substantially only light having a wavelength of from about 320 to about 400 nm. Examples of UVA filters include, but are not limited to, the ultraviolet UG-11 filter (Schott Glass Technologies, Duryea, Pa. USA). The resulting image may be rich in red color because of the long wavelength pass of UVA filter. In one embodiment, when utilizing a digital camera, either the blue or green channel, preferably the blue channel, of the RGB image is selected for viewing, resulting in a black and white image.

Benefits of an ultraviolet A photograph include, but are not limited to, enhanced appearance of pigmented macules on the skin and surface features such as bumps and wrinkles. Ultraviolet A photography may be used to determine the uniformity of application of topical products, such as sunscreens and of make-ups, that contain materials that absorb ultraviolet radiation. In addition, since melanin pigmentation more strongly absorbs UVA radiation than visible light, illuminating the skin with UVA radiation gives an enhanced contrast between normal skin and hyperpigmented skin. Furthermore, the pigmented macules are visualized as dark spots on a bright background due to the scattering and the fluorescence of the dermal collagen matrix. The image recorded by the camera includes both the reflection of ultraviolet A radiation and fluorescence of the collagen. The resulting black and white image obtained by the blue or green channel from a digital camera provides an enhanced view of the distribution of pigmented macules on the skin (e.g., the face). For customers with deeply pigmented skin, the red channel may be selected.

In another embodiment, the flash units are further filtered with a red blocking filter. Examples of such red blocking filter include, but is not limited to, a KG-5 filter (Schott Glass Technologies). Such filters may assist in correcting the red appearance of the image.

Polarized Photography

Preferably, other photographs are also taken with the same or different cameras with other light sources, either simultaneously or in rapid succession to produce multiple images of the customer. Another preferred photograph that is taken is a polarized photograph. What is meant by polarized photograph is a photograph of the customer taken (i) with a light source that emits light through a polarizing filter and/or (ii) through a polarized filter that filters light prior to or after entering the camera's lens.

In one embodiment, the camera and one or more flash units, preferably two, are on about the same plane as the customer's face, and the flash units are placed so that the angle formed by each flash unit(s), the customer's skin, and the camera, is about 35 to 55 degrees, such as about 45 degrees. In one embodiment, a polarizing filter is placed in front of each flash unit. By “polarizing filter” is meant a filter that filters incoming light to emit substantially only polarized light. As used herein, “substantially” means at least 75 percent, preferably, 90 percent, and most preferably at least 95 percent.

Examples of a polarizing filter include, but are not limited to, polarizing plates such as those available from Edmund Scientific (Barrington, N.J., USA), polarizing prisms such as Glan Thomson polarizing prisms, or a polarizing reflector that reflects light at about the Brewster angle. Polarizing filters may be linear or circular polarizing filters. In a further embodiment, a light diffuser is placed between the flash unit and the polarizing filter.

In one embodiment, a linear polarizing filter is used at the light source and the linear polarizing filter is arranged such that the electric filed of the emitted light is about perpendicular to the plane formed by the light source, the customer's face, and the camera. In another embodiment, a linear polarizing filter is used at the light source and the linear polarizing filter is arranged such that the electric field of the emitted light is about parallel to the plane formed by the light source, the customer's face, and the camera.

In a further embodiment, the flash unit(s) are positioned on a horizontal plane with the camera and the customer's skin and the polarizing filter is a linear polarizing filter oriented so that the electric field of the transmitted light is in the vertical direction (e.g., perpendicular to the plane). In this orientation, the critical angle for total internal reflection from within the top corneocytes is 45 degrees, thereby resulting in an image that is dominated by the light thus reflected from the corneocytes. The resulting image has a high degree of glare, which is further enhanced when an optical coupling medium, such as sebum or “oils,” is present on the surface of the corneocytes. The polarized image, thereby, allows an estimate to be made as to the oiliness of the customer's skin. It also provides insight into the number and severity of pores on the cheek and forehead areas of the facial skin. Other desired outcomes of polarized photography include, but are not limited to, an enhanced image of surface features such as fine lines, skin texture, scales and vellous hair.

In another embodiment, the flash unit(s) are positioned on a vertical plane above the camera and the customer's skin so that the angle formed by the flash unit, customer's skin, and camera is about 35 to 55 degrees such as about 45 degrees and flash unit(s) are filtered with linear polarizing filter that is placed with the transmitted electric field in the vertical direction (e.g., parallel to the plane). In this arrangement the surface glare from the skin is minimized, thus, enhancing the subsurface features of the skin, such as erythema (redness), blood vessels, and pigmentation.

Polarized light sources on both on the horizontal and vertical planes with the camera and the customer's skin can be used to enhance specific aspects of the skin (e.g., the face) that are partially shaded with the use of polarized light sources only on the horizontal or vertical planes alone.

In one embodiment, the photograph of the customer is taken both with a light source that emits lights through a polarizing filter and through a polarizing filter that filters the light prior to or after entering the camera's lens. When the polarizing filters are in the same orientation with each other (e.g., both horizontal or both vertical), surface features of the skin such as scales, wrinkles, fine lines, pores, and hairs are visually enhanced. When the polarizing filters are aligned perpendicular to each other (e.g., one horizontal and one vertical), subsurface features of the skin such as erythema, pigmentation, blood vessels, and hair, are visually enhanced.

Blue Fluorescence Photography.

In one embodiment, the method includes the step of taking a blue fluorescence photograph of the customer. What is meant by “blue fluorescence photograph” is a photograph of the customer taken with a light source that emits substantially only blue light or emits light through a blue filter. What is meant by “blue light” is light having a wavelength from about 380 to about 430 nm.

In one embodiment, one or more, preferably two, flash units are filtered with a blue filter. What is meant by a “blue filter” is a filter that filters incoming light to emit substantially only blue light. Examples of such blue filters include, but are not limited to, interference filters such as those available from Melles Griot (Irvine, Calif. USA) or dielectric filters.

In one embodiment, the light entering the camera is also filtered (e.g., prior to or after entering the lens of the camera) with a long pass filter to substantially eliminate light having a wavelength below about 400 nm. Examples of long pass filters include, but are not limited to, GG-420 or GG440 filters (Schott Glass Technologies) and Kodak Wratten No. 8 (Eastman Kodak, Rochester, N.Y. USA). In one embodiment, the flash units and filters are placed on either side of the camera at approximately the same horizontal plane as the skin sample of the customer.

This type of photography produces bright images of the distribution of coproporphyrin produced by the bacteria P. acnes and of horns. What is meant by a “horn” is a mixture of sebaceous lipids, keratinocytes, and possibly sebocytes impacted in open comedones and blackheads on the skin. By using substantially only blue light that is within the Soret absorption band of porphyrins, the fluorescence emission of coproporphyrin is maximized. Excitation in this range also yields bright emission images of the distribution of “horns” because the fluorescence yield of horns is higher when excited in the blue region of the spectrum.

In one embodiment, when utilizing a digital camera, the color image may be viewed showing the distribution of coproporphyrin and therefore the sites of maximum p. acnes concentration, which appears red in the image. The image also contains bright white spots, which correspond to clogged pores or open comedones. In another embodiment the green channel of the RGB image is selected to enhance the horn fluorescence emission and the red channel may be selected to enhance the fluorescence emission of porphyrins from p. acnes. The resulting black and white images, thus, provide excellent imaging of small vessels because hemoglobin has its Soret band in the same wavelength range as porphyrins. In one embodiment, these vessels are visualized using either the blue or the green channel of the RBG image.

The scores from each image are used with the subjective personal information to select the appropriate product recommendation, service recommendation, and activity recommendation of the personalized skin care program for the customer based on her individual needs and conditions. An example of a personalized skin care program is illustrated in FIG. 5. The personalized skin care program is then provided to the customer in a counseling session where the professional skin care consultant sits with the customer in an image viewing room or counseling area, which is a private or semi-private portion of the retail location. The consultant may show the images to the customer in this counseling session so that the customer may see certain features of her skin, such as, for example, the extent of photodamage sustained by her skin. As the consultant provides the details of the personalized skin care program to the customer, the consultant may also provide the customer with brochures or other educational information for her own individualized needs, or with schedules and pricing of available activities or services recommended in the customer's program. The activities or services may be provided in the retail location or they may be provided at an alternate location. The products recommended to the customer as part of her personalized skin care program are available for her purchase in the retail location.

The retail location is preferably designed with one imaging station in data communication with multiple image viewing rooms or counseling areas. Thus, the customer has her image acquired in the imaging station, which is a relatively quick process; and she then moves to one of several counseling areas. The counseling session generally takes more time than the imaging; thus, it is more efficient to have multiple counseling areas where multiple customers may meet with their respective skin care consultants at any given time.

### EXAMPLE 2

### Method of Providing a Personalized Wellness Program Using a Psychometric Measurement of Stress

In another embodiment of the invention, the customer enters the retail location and identifies herself as a new customer to a professional wellness consultant. The consultant invites her to be seated at a computer terminal, where the customer types in her name, address, phone number, and other identifying information prompted by questions on the computer screen. She is then asked to provide subjective information concerning her age, height, and weight, personal care product use preferences, exercise habits, medication usage, energy levels, personal concerns and their importance, dietary habits, allergies, self-described stress levels, sleep habits, alcohol use habits, tobacco use habits, and menstrual cycle information, which is also typed into the computer either by the customer herself or by the consultant upon obtaining the customer's information.

The customer is then invited to complete the Perceived Stress Scale (PSS) to determine a psychometric measurement of her stress. The PSS is a well-established stress psychometric tool developed by Cohen et al. and described in the following, which are incorporated herein by reference: “A Global Measure of Perceived Stress.” Journal of Health and Social Behavior, 24, 385-396; Cohen, S., Kamarck, T., and Mermelstein, R. (1983); and Measuring Stress: A Guide for Health and Social Scientists, Oxford University Press, 1997, pages 138-139.

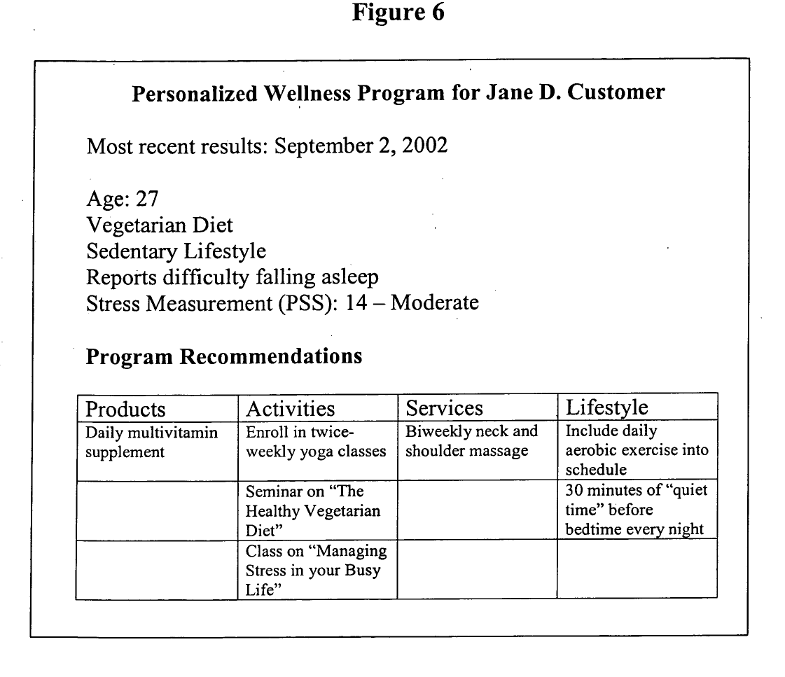

The customer's responses to the PSS are then analyzed according to the method described by Cohen et al. in the aforementioned references to obtain the customer's stress measurement. The stress measurement and the customer's other personal information are used to create a personalized wellness program for the customer based on her individual needs, conditions, and stress level. The wellness program includes a recommendation to improve the customer's stress measurement. An example of a personalized wellness program is illustrated in FIG. 6. In this example, the customer's stress measurement is 14, which is in the moderate range, and the customer reports having difficulty falling asleep. The customer's personalized wellness program includes recommendations for yoga classes, daily aerobic exercise, and 30 minutes of “quiet time” before bedtime to help her sleep better. These measures are recommended to help improve the customer's stress measurement by lowering her stress level.

The personalized wellness program is provided to the customer in a counseling session where the wellness consultant sits with the customer in a counseling area, which is a private or semi-private portion of the retail location. The consultant shows the customer her stress measurements and reviews the customer's wellness program with her. The customer is invited to return for an update to her personalized wellness program after she has implemented the recommendations for a time.

### EXAMPLE 3

### Method of Providing a Personalized Wellness Program Using a Measurement of Stress Hormone

In a further embodiment of the invention, the customer enters the retail location and identifies herself as a new customer to a professional wellness consultant. The consultant invites her to be seated at a computer terminal, where the customer types in her name, address, phone number, and other identifying information prompted by questions on the computer screen. She is then asked to provide subjective information concerning her age, height, and weight, personal care product use preferences, exercise habits, medication usage, energy levels, personal concerns and their importance, dietary habits, allergies, self-described stress levels, sleep habits, alcohol use habits, tobacco use habits, and menstrual cycle information, which is also typed into the computer either by the customer herself or by the consultant upon obtaining the customer's information.

The customer is then given a kit to take home for collection of saliva samples for cortisol analysis. The kit contains vials for collecting saliva samples, and instructions about how and when to collect the samples. The samples are used to determine the customer's cortisol levels on a “baseline” or low-stress day, and on a higher stress day.

The method of this example, which is used for collection of the saliva samples and determination of the cortisol levels is described in commonly-owned co-pending United Stated patent applications with Ser. Nos. 09/676,876 and 10/012,626, which are incorporated herein in their entirety by reference. In this exemplary method, salivary cortisol is measured and used as an indicator of stress. The level of cortisol can be easily measured by taking a saliva sample from the person, and then performing the appropriate ELISA or RIA methodology as taught, for example, by Kischbaum, C., Hellhammer, D H (1989) “Salivary Cortisol in psychobiological research: An Overview”, Neuropsychobiology 22: 150-169; Cooper T R, Trunkfield, H R, Zanella A J, Booth, W D (1989) “An Enzyme-linked Immunosorbent Assay for Cortisol in the Saliva of Man and Farm Animals”, J. Endocrinol 123: R13:R16; and Dressendoerfer, R. A., Kirschbaum, C., Rohde, W., Stahl, F., and Strasburger, C. J. (1992) “Synthesis of a Cortisol-Biotin Conjugate and Evaluation as a Tracer in an Immunoassay for Salivary Cortisol Measurement”, J. Steroid Biochem. Mo. Biol 43 683-692, the disclosures of which are incorporated herein by reference.

Since each person is unique in terms of his or her basal cortisol level, and his or her responses to stress, it is preferable that cortisol readings be taken over a single day, to establish a baseline for that individual. This information is then captured into an analysis table, which can then be compared against future measurements. In addition, cortisol level at the time point 4 hours after waking is also a good indicator of that person's stress levels throughout the day, and comparisons on subsequent days against that time point are also useful.

Accordingly, in this method, the activity of the hypothalamus-pituitary-adrenal system is measured by measuring at least one of the following: (i waking adrenocortical hormone; (ii) adrenocortical hormone at any time in the period from about 4 to about 8 hours following morning waking; (iii) total daily free adrenocortical hormone; and (iv) total daily free adrenocortical hormone minus the morning peak.

Since there is no “average or normal” stress temperature for every individual, one must first select a day to take a baseline measurement. The choice of the day can be based on any number of reasons, but two key reasons are preferable. First, the day could be chosen, because the individual is “stress” free, e.g. after a vacation, or some restful period. In this case, one is using this invention to measure any increases in stress in the individual. On the other hand, the initial day could be a representative day where the individual has some level of stress. In this case, subsequent measures can be used to determine the amount and effectiveness of a stress management or intervention technique.

On the baseline day, the person is instructed to collect a number of saliva samples throughout the day at the prescribed times (for example, upon waking, 30 minutes post waking, 60 minutes post waking, 4 hours post waking, 8 hours post waking, and 12 hours post waking). Prescribed times are selected in order to determine the level of cortisol in saliva throughout the wakeful period of a 24 hour day, and it is obvious to one of ordinary skill in the art, that these is times, where possible, should be selected in order to collect a saliva sample which will give the most accurate representation of a person's cortisol levels as determined in the subsequent assay procedure.

Samples can be collected throughout the day, for example, prompted by a Personal Digital Assistant (PDA), and the samples can then be sent to a testing facility or dropped off at the retail location of the present invention. The results can be available, preferably, when the person visits the retail location, or alternatively, the results may be available via the internet or by a written report that is mailed or otherwise delivered to the person at his or her home or other location. In addition, an in situ measurement could be done, and fed into a PDA. These samples would then be analyzed for cortisol values at each time point using the appropriate analytical techniques, including but not limited to, ELISA and/or RIA methods discussed above.

Once these values are obtained, the resulting time course data can be used to calculate four different stress results of the individual. These measurements are waking cortisol, 4 hours after waking cortisol, total daily free cortisol, and total daily free cortisol minus waking cortisol, which have been previously outlined. One or more of these stress measurements can be used to establish a baseline set of data. On a subsequent day of the individual's choice, the same procedure is followed, collecting the saliva samples, having them analyzed for cortisol, and then calculating the four different measures of stress, for a more complete picture. Once these values have been calculated, a comparison can be done between the measured values and the baseline values, to determine the change, if any, in stress “temperature” of the individual from the baseline measurement to the current day. A comparison of all of these values is necessary to help dimensionalize the magnitude of effect one way or the other.

As each of the four measures of HPA activity described above have different sensitivity, it would be expected that a major change in one's stress level should be evidenced by the corresponding changes in a majority of the stress measurements. On the other hand, small changes, one way or another in an unconcerted manner, would probably point to experimental error, and subsequent measurements on future days should be undertaken to gain a more complete picture of the person's stress level.

The methods described here can be used to monitor the stress hormone levels of a person, and where appropriate, to administer a treatment to either reduce or increase the activity of the hypothalamus-pituitary-adrenal system of the person, thus reducing or increasing the person's stress measurement as needed.

After the saliva samples are analyzed for cortisol and the stress measurements are obtained, the customer visits the retail outlet again to receive her personalized wellness program, which has been prepared using her personal information, including her stress measurements. The personalized wellness program includes a recommendation for at least one product, service, or activity to improve the customer's stress measurement. For example, if the customer's stress measurement on her high stress day was elevated, she might receive a recommendation to listen to soothing music during her commute home in the evening, or to take a warm bath with bath product having a pleasing fragrance just before bedtime. Other recommendations might also be made based on the customer's level of stress hormones and other individual needs and preferences.

### EXAMPLE 4

### Method of Providing a Personalized Wellness Program Using a Psychometric Measurement of Stress and a Stress Hormone Measurement

In the embodiment of this example, a customer enters the retail outlet and is greeted by a professional wellness consultant, who invites her to provide personal information as described in the example above. The customer is then asked to complete the Perceived Stress Scale (PSS) according to the method above. The customer is also given a cortisol measurement kit as described above and asked to collect saliva samples on a “baseline” day.

Once the saliva samples have been returned and analyzed, the customer returns to the retail outlet to obtain her personalized wellness program. The personalized wellness program is created using the customer's PSS-score and other individual need and preference information. The personalized wellness program is given to the customer by a wellness consultant in a private or semi-private counseling session.

The customer is also provided with a second cortisol testing kit and instructed to collect more saliva samples on a day after she has been following the recommendations of the personalized wellness program for 2 weeks. These second cortisol samples are then returned to the retail outlet or other location for analysis. The results of the analysis, or the second stress measurements, are used to determine whether the personalized wellness program is effective for the customer.

Modifications to the program may be made based upon the second stress measurements. For example, if the customer's stress measurements have decreased significantly, her wellness program may be modified slightly, or left the same, since the drop in stress measurements indicates that the program is effective at improving the customer's stress measurement.

The customer is then provided with the results of the analysis and invited to return to the retail outlet for a follow-up counseling session with a wellness consultant to receive her updated wellness program or encouragement to continue on with the original wellness program.

The specification and embodiments above are presented to aid in the complete and non-limiting understanding of the invention disclosed herein. Since many variations and embodiments of the invention can be made without departing from its spirit and scope, the invention resides in the claims hereinafter appended.

We claim:

1. A method of providing an individualized personal care program to a customer, the method comprising, in a first retail location:
a) obtaining personal information from a customer;
b) using the personal information to create an individualized personal care program for the customer;
c) providing the individualized personal care program to the customer, wherein the individualized personal care program comprises at least two elements selected from the group consisting of a recommendation for at least one personal care product, a recommendation for at least one personal care activity, and a recommendation for at least one personal care service;
d) wherein the first retail location is one of a plurality of retail locations in data communication with one another.

2. The method of claim 1 wherein data comprising the personal information is communicated from the first retail location to a second retail location.

3. The method of claim 1 wherein data comprising the individualized personal care program is communicated from the first retail location to a second retail location.

4. The method of claim 1 wherein data comprising the personal information and the individualized personal care program are communicated from the first retail location to a second retail location.

5. The method of claim 4 wherein the data comprising the personal information and the individualized personal care program are communicated from the first retail location to the second retail location at the customer's direction

6. The method of claim 1 wherein the individualized personal care program is an individualized personal skin care program.

7. The method of claim 6 wherein the at least one personal care product is a skin care product.

8. The method of claim 6 wherein the at least one personal care activity is a skin care activity.

9. The method of claim 6 wherein the at least one personal care service is a skin care service.

10. The method of claim 1 wherein the individualized personal care program is an individualized personal hair care program.

11. The method of claim 1 wherein the individualized personal care program is an individualized personal wellness program.

12. A method of providing an individualized personal care program to a customer in a retail shopping environment, the method comprising, in a retail shopping environment:
a) obtaining personal information comprising objective information from a customer;
b) using the personal information to generate individualized personal care needs for the customer;
c) evaluating the individualized personal care needs against standards that reflect needs for personal care products, needs for personal care services, and needs for personal care activities, to create an individualized personal care needs assessment;
d) using the individualized personal care needs assessment to create an individualized personal care program, the individualized personal care program comprising at least one element selected from the group consisting of a personal care product, a personal care service, and a personal care activity; and
e) providing the individualized personal care program to the customer.

13. The method of claim 12 wherein the personal care needs comprise skin care needs, hair care needs, wellness needs, or any combination thereof.

14. A method of providing a personalized skin care program to a customer in a retail shopping environment, the method comprising, in a retail shopping environment:
a) obtaining personal information comprising objective information from a customer;
b) using the personal information to create a personalized skin care program for the customer;
c) providing the personalized skin care program to the customer, wherein the personalized skin care program comprises at least two elements selected from the group consisting of a recommendation for at least one skin care product, a recommendation for at least one skin care activity, and a recommendation for at least one skin care service.

15. The method of claim 14 wherein the personal information is retained with a personal identifier unique to the customer.

16. The method of claim 14 wherein the personal information comprises subjective information.

17. The method of claim 16 wherein the personal information is obtained from the customer by questioning means.

18. The method of claim 17 wherein the questioning means is a personal interview.

19. The method of claim 17 wherein the questioning means is a written questionnaire.

20. The method of claim 14 wherein the personal information comprises objective information.

21. The method of claim 20 wherein the personal information is obtained by imaging the customer's skin to obtain a skin image.

22. The method of claim 21 wherein the customer's skin image is electronically analyzed.

23. The method of claim of claim 14 wherein the skin care activity is an educational seminar.

24. The method of claim 14 wherein the skin care activity is a recommendation for the customer to be examined by a dermatologist.

25. The method of claim 14 wherein the skin care service is a facial.

26. The method of claim 14 wherein the skin care service is a massage.

27. The method of claim 14 wherein the skin care service is a makeover.

28. The method of claim 14 wherein the personalized skin care program comprises personalized recommendations for cosmetic and fashion colors.

29. A method of providing a personalized skin care program to a customer in a retail shopping environment, the method comprising
a) obtaining personal information from a customer;
b) imaging a portion of the customer's skin to create a skin image;
c) analyzing the skin image to create a skin image analysis report;
d) providing an assessment of the portion of the customer's skin by a professional skin care consultant;
e) using the personal information, the assessment, and the skin image analysis report to create a personalized skin care program for the customer; and
f) providing the personalized skin care program to the customer, wherein the skin care program comprises recommendations for at least one skin care product, at least one skin care activity, and at least one skin care service.

30. The method of claim 29 wherein the personalized skin care program is provided to the customer through one or more skin care counseling sessions with a professional skin care consultant.

31. The method of claim 29 wherein the personalized skin care program is provided to the customer through a written report.

32. The method of claim 29 wherein the at least one skin care activity is selected from the group consisting of educational seminars, an appointment with a dermatologist, an exercise program, nutritional counseling, or increased hydration.

33. The method of claim 29 wherein the at least one skin care product is selected from the group consisting of cleansers, moisturizers, toners, sunscreens, skin lighteners, skin darkeners, wrinkle treatments, unwanted hair diminishing products, color cosmetics, astringents, acne treatments, oil-reduction products, sunless tanning products, and skin firming treatments.

34. The method of claim 29 wherein the at least one skin care service is selected from the group consisting of facials, masks, makeup consultations, fashion color consultations, massages, tanning services, unwanted hair removal, manicures, and pedicures.

35. The method of claim 29 wherein the personal information includes subjective information.

36. The method of claim 29 wherein the personalized skin care program comprises personalized recommendations for cosmetic and fashion colors.

37. The method of claim 29 wherein the personalized skin care program comprises a recommendation for the customer to be examined by a dermatologist.

38. The method of claim 36 further comprising transmitting the skin image to a dermatologist.

39. The method of claim 37 wherein the image is transmitted electronically.

40. The method of claim 29 wherein the professional skin care consultant is an aesthetician.

41. A method of providing personalized skin care education to a customer, the method comprising
a) obtaining personal information from a customer;
b) imaging a portion of the customer's skin to create a skin image;
c) computationally analyzing the skin image to create a skin image analysis report;
d) providing an assessment of the portion of the customer's skin by a professional skin care consultant;
e) using the personal information, the assessment, and the skin image analysis report to create an itemized list of a first specific skin care need and at least a second specific skin care need for the customer;
f) providing the customer with the itemized list and information about educational seminars addressing at least the first skin care need; and
g) providing a first educational seminar addressing the first specific skin care need and at least a second educational seminar addressing the second specific skin care need.

42. A method of providing a personalized skin care program to a customer in a retail shopping environment, the method comprising, in a retail shopping environment,
a) obtaining personal information from a customer;
b) imaging a portion of the customer's skin to create a skin image;
c) computationally analyzing the skin image to create a skin image analysis report;
d) providing an assessment of the portion of the customer's skin by a professional skin care consultant;
e) using at least two of the personal information, the assessment, and the skin image analysis report to create a personalized skin care program for the customer; and
f) providing the personalized skin care program to the customer, wherein the skin care program comprises recommendations for at least one skin care product, at least one skin care activity, and at least one skin care service.

43. A method of providing a personalized skin care program to a customer in a retail shopping environment, the method comprising, in a retail shopping environment,
a) obtaining personal information from a customer;
b) imaging a portion of the customer's skin to create a skin image;
c) analyzing the skin image to create a skin image analysis report;
d) providing an assessment of the portion of the customer's skin by a professional skin care consultant;
e) using the personal information, the assessment, and the skin image analysis report to create a personalized skin care program for the customer; and
f) providing the personalized skin care program to the customer, wherein the skin care program comprises at least two elements selected from the group consisting of a recommendation for at least one skin care product, a recommendation for at least one skin care activity, and a recommendation for at least one skin care service.

44. The method of claim 43 wherein the personal information, the assessment, and the skin care analysis report are retained with a personal identifier unique to the customer.

45. The method of claim 43 wherein the portion of the customers skin is imaged to create a first skin image at a first time, and the portion of the customers skin is imaged to create a second skin image at a second time which is later than the first time.

46. The method of claim 45 wherein the personalized skin care program further comprises a comparison of the first skin image and the second skin image.

47. A method of providing a personalized hair care program to a customer in a retail shopping environment, the method comprising, in a retail shopping environment,
a) obtaining personal information from a customer;
b) imaging a portion of the customer's hair to create a hair image;
c) analyzing the hair image to create a hair image analysis report;
d) providing an assessment of the portion of the customers hair by a professional hair care consultant;
e) using the personal information, the assessment, and the hair image analysis report to create a personalized hair care program for the customer; and
f) providing the personalized hair care program to the customer, wherein the hair care program comprises at least two elements selected from the group consisting of a recommendation for at least one hair care product, a recommendation for at least one hair care activity, and a recommendation for at least one hair care service.

48. The method of claim 47 wherein at least one of the personal information, the assessment, and the hair care analysis report is retained with a personal identifier unique to the customer.

49. The method of claim 48 wherein the portion of the customer's hair is imaged to create a first hair image at a first time, and the portion of the customer's hair is imaged to create a second hair image at a second time which is later than the first time.

50. The method of claim 49 wherein the personalized hair care program further comprises a comparison of the first hair image and the second hair image.

51. The method of claim 49 wherein the personal identifier is used to retrieve the first hair image.

52. A method of providing a personalized wellness program to a customer in a retail shopping environment, the method comprising, in a retail shopping environment,
a) obtaining personal information from a customer;
b) collecting a saliva sample from the customer;
c) analyzing the saliva sample for cortisol determine a cortisol level for the customer;
d) using the personal information and the cortisol level to create a personalized wellness program for the customer; and
e) providing the personalized wellness program to the customer, wherein the wellness program comprises at least two elements selected from the group consisting of a recommendation for at least one wellness product, a recommendation for at least one wellness activity, and a recommendation for at least one wellness service.

53. The method of claim 52 wherein the wellness product comprises a sensory stimulus.

54. The method of claim 53 wherein the sensory stimulus is an olfactory stimulus.

55. The method of claim 52 wherein the wellness activity comprises a sensory regimen.

56. The method of claim 52 wherein the wellness service comprises an educational seminar.

57. A method of providing a personalized wellness program to a customer in a retail shopping environment, the method comprising:
a) obtaining personal information from a customer;
b) obtaining objective information comprising a stress measurement from the customer;
c) using the personal information and the objective information to create a personalized wellness program for the customer; and
d) providing the personalized wellness program to the customer, wherein the personalized wellness program comprises a recommendation for a product, service, or activity to improve the customer's stress measurement.

58. The method of claim 57 wherein the stress measurement comprises a measurement of stress hormone level.

59. The method of claim 58 wherein the stress hormone is cortisol.

60. The method of claim 57 wherein the stress measurement comprises a psychometric measurement.

61. The method of claim 57 wherein the stress measurement comprises a psychometric measurement and a measurement of stress hormone level.

62. The method of claim 57 wherein the personalized wellness program comprises a recommendation for a product, activity, or service to decrease stress measurement.

63. The method of claim 62 wherein the personalized wellness program comprises a recommendation for a product, activity or service to decrease stress hormone level.

64. The method of claim 59 wherein the cortisol is measured by analyzing a saliva sample from the customer.
